(19) United States
(12) Patent Application Publication
(10) Pub. No.: US 2008/0186299 A1
(43) Pub. Date: Aug. 7, 2008

(54) DISPLAY DEVICE

(76) Inventors: Takashi Yoshimoto, Mobara (JP); Shouji Nagao, Chiba (JP); Hidetoshi Kida, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/025,816

(22) Filed: Feb. 5, 2008

(30) Foreign Application Priority Data
Feb. 5, 2007 (JP) 2007-025483

(51) Int. Cl. G06F 3/038

(52) U.S. Cl. 345/211

(57) ABSTRACT

A display device mounts a video line drive circuit on a lateral side of a display panel while reducing a vertical picture frame size of the display panel. A display device includes: a display panel having a plurality of video lines; and a video line drive circuit which supplies a video voltage to the respective video lines, the video line drive circuit including a control circuit and a shift register circuit which outputs a plurality of acquisition pulses, wherein the shift register circuit is divided into two shift resister circuits consisting of a first shift register circuit and a second shift register circuit, the first shift register circuit forms a first operation control circuit on one end thereof and a second operation control circuit one another end thereof, the second shift register circuit forms a third operation control circuit on one end thereof and a fourth operation control circuit one another end thereof, and the control circuit selects one operation control circuit out of the first operation control circuit and the second operation control circuit of the first shift register circuit and inputs a start pulse to the selected operation control circuit, and selects one operation control circuit out of the third operation control circuit and the fourth operation control circuit of the second shift register circuit and inputs a start pulse to the selected operation control circuit.

### CLAIM OF PRIORITY

The present application claims priority from Japanese application serial No. 2007-25483 filed on Feb. 5, 2007, the content of which is hereby incorporated by reference into this application.

### BACKGROUND OF THE INVENTION

1. Field of the Invention

The present invention relates to a display device, and more particularly to a display device which includes a video line drive circuit (drain driver) mountable on a short side or a long side of a display panel.

2. Description of the Related Art

As a high-definition color monitor of a computer or other information equipment or a display device of a television receiver set, a liquid crystal display module has been popularly used.

The liquid crystal display module basically includes a so-called liquid crystal display panel which sandwiches a liquid crystal layer between two (a pair of) substrates, wherein at least one of the substrates is made of transparent glass or the like. By selectively applying a voltage to various electrodes for forming pixels which are formed on the substrates of the liquid crystal display panel, predetermined pixels are turned on or off. Such a liquid crystal display module exhibits excellent contrast performance and excellent high-speed display performance.

FIG. 7 is a block diagram showing the schematic constitution of a conventional liquid crystal display module. As shown in the drawing, a liquid crystal display panel (PNL) includes a plurality of video lines (VL1 to VLn) and a plurality of scanning lines (GL1 to GLm).

Further, the liquid crystal display panel (PNL) includes a plurality of sub pixels, and each sub pixel includes a thin film transistor (TFT), a pixel electrode (PX) which is connected to a source electrode (or a drain electrode) of the thin film transistor (TFT), and a counter electrode (CT) which faces the pixel electrode (PX) and a liquid crystal layer in an opposed manner. Here, symbol Clc indicates a liquid crystal capacitance which equivalently indicates the liquid crystal layer, and symbol Cadd indicates a holding capacitance formed between the counter electrode (CT) and the pixel electrode (PX).

The drain electrodes (or a source electrode) of the thin film transistors (TFT) of the respective sub pixels arranged in the column direction are respectively connected to the video line (VL1 to VLn), and the respective video lines (VL1 to VLn) are connected to a video line drive circuit (also referred to as a drain driver; DRV) which supplies video voltages corresponding to display data.

Further, gate electrodes of the thin film transistors (TFT) of the respective sub pixels arranged in the row direction are respectively connected to the scanning line (GL1 to GLm), and the respective scanning lines (GL1 to GLm) are connected to a scanning line drive circuit (also referred to as a gate driver; GDRV) which supplies scanning voltages (positive or negative bias voltage) to gates of the thin film transistors (TFT) for 1 horizontal scanning time.

In displaying an image on the liquid crystal display panel (PNL), the scanning line drive circuit (GDRV) selects the scanning lines (GL1 to GLm) from top to bottom (in the order of GL1→GLm) or from bottom to top (in the order of GLm→GL1), while the video line drive circuit (DRV) supplies video voltages corresponding to display data to the video lines (VL1 to VLn) during a selection period of one scanning line.

A voltage supplied to the video lines (VL1 to VLn) is outputted to the pixel electrodes (PX) via the thin film transistors (TFT), and eventually, a charge is charged to the holding capacitances (Cadd) and a liquid crystal capacitance (Clc) so as to control liquid crystal molecules and hence, an image is displayed on the liquid crystal display panel (PNL).

### SUMMARY OF THE INVENTION

As shown in FIG. 7, in the conventional liquid crystal display module, the video line drive circuit (DRV) is mounted below the liquid crystal display panel (outside one long side out of two long sides of the liquid crystal display panel).

On the other hand, there has been a demand for the reduction of a vertical picture frame size of the liquid crystal display panel (PNL). As a technique which satisfies such a demand, as shown in FIG. 8, it is effective to mount the video line drive circuit (DRV) on a lateral side of the liquid crystal display panel (PNL) (outside one short side out of two short sides of the liquid crystal display panel).

However, when the conventional video line drive circuit (DRV) is mounted on the lateral side of the liquid crystal display panel (PNL), it is necessary to arrange connection lines for connecting the video lines (VL1 to VLn) and video voltage output terminals of the video line drive circuit (DRV) on an upper side or a lower side of the liquid crystal display panel (PNL) and hence, there arises a drawback that the picture frame size becomes large.

Accordingly, as shown in FIG. 8, the video lines (VL1 to VLn) are divided in two, that is, into a first group of video lines (VL1 to VLn/2) and a second group of video lines (VL(n/2+1) to VLn). Here, it is necessary to connect the respective video lines (VL1 to VLn/2) of the first group to the video voltage output terminals of the video line drive circuit (DRV) via the connection lines (VL(n/2+1) to VLn) arranged on the upper side of the liquid crystal display panel (PNL), and it is also necessary to connect the respective video lines (VL(n/2+1) to VLn) of the second group to the video voltage output terminals of the video line drive circuit (DRV) via the connection lines (KL1 to KLn/2) arranged on the lower side of the liquid crystal display panel (PNL).

However, as shown in FIG. 8, when the connection lines (KL1 to KLn/2), (KL(n/2+1) to KLn) are arranged on the upper and lower sides of the liquid crystal display panel (PNL), it is necessary to change over the order of the display data outputted from the video voltage output terminals of the video line drive circuit (DRV) in response to the allocation of the connection lines. However, the conventional video line drive circuit (DRV) cannot cope with the changeover of the order of the display data.

The present invention has been made to overcome the above-mentioned drawbacks of the related art, and it is an object of the present invention to provide a technique which can mount a video line drive circuit on a lateral side of a display panel while reducing a vertical picture frame size of the liquid crystal display panel in a display device.

The above-mentioned and other object and novel features of the present invention will become apparent from the description of this specification and attached drawings.

To briefly explain the summary of typical inventions among the inventions disclosed in this specification, they are as follows.

(1) In a display device which includes a display panel having a plurality of video lines and a video line drive circuit which supplies a video voltage to the respective video lines, wherein the video line drive circuit includes a control circuit and a shift register circuit which outputs a plurality of acquisition pulses, the shift register circuit is divided in two, that is, into a first shift register circuit and a second shift register circuit, the first shift register circuit forms a first operation control circuit on one end thereof and a second operation control circuit on another end thereof, the second shift register circuit forms a third operation control circuit one end thereof and a fourth operation control circuit on another end thereof, and the control circuit selects one operation control circuit out of the first operation control circuit and the second operation control circuit of the first shift register circuit and inputs a start pulse to the selected operation control circuit, and selects one operation control circuit out of the third operation control circuit and the fourth operation control circuit of the second shift register circuit and inputs a start pulse to the selected operation control circuit.

(2) In the display device having the constitution (1), the video line drive circuit includes a bit latch circuit which sequentially latches a plurality of display data inputted from the outside in response to the acquisition pulses which are sequentially outputted from the shift register circuit, a line latch circuit which latches the plurality of display data latched by the bit latch circuit, a D/A converting circuit which generates a plurality of video voltages corresponding to the display data based on the plurality of display data latched by the line latch circuit, and an output circuit which outputs the plurality of video voltages outputted from the D/A converting circuit to the respective corresponding video lines.

(3) In the display device having the constitution (1) or (2), an operational clock is not inputted to the first shift register circuit and the second shift register circuit during periods other than a period in which the acquisition pulses are generated and outputted.

(4) In the display device having any one of the constitutions (1) to (3), the video line drive circuit is arranged on one side out of two sides of the display panel which intersect the extending direction of the video lines, and the control circuit firstly inputs the start pulse to the first operation control circuit of the first shift register circuit and, thereafter, inputs the start pulse to the third operation control circuit of the second shift register circuit at outputting timing of the acquisition pulse firstly outputted from the second shift register circuit or firstly inputs the start pulse to the fourth operation control circuit of the second shift register circuit and, thereafter, inputs the start pulse to the second operation control circuit of the first shift register circuit at outputting timing of the acquisition pulse firstly outputted from the first shift register circuit.

(5) In the display device having the constitution (4), the display panel includes a plurality of scanning lines and a scanning line drive circuit which supplies scanning voltages to the plurality of scanning lines, the video line drive circuit includes a first control signal generating circuit and a second control signal generating circuit which control the scanning line drive circuit one on each end thereof in the longitudinal direction, the scanning line drive circuit is arranged on one side out of two sides of the display panel in the extending direction of the video lines, and a control signal is supplied to the scanning line drive circuit from either one of the first control signal generating circuit and the second control signal generating circuit of the video line drive circuit.

(6) In the display device having any one of the constitutions (1) to (3), the video line drive circuit is arranged on one side out of two sides of the display panel along the extending direction of the video lines,

the plurality of video lines is divided into a first group and a second group,

the respective video lines of the first group are connected to video voltage output terminals of the video line drive circuit corresponding to the second shift register circuit via connection lines arranged outside one side out of two sides of the display panel which intersect the extending direction of the video lines,

the respective video lines of the second group are connected to video voltage output terminals of the video line drive circuit corresponding to the first shift register circuit via connection lines arranged outside another side out of two sides of the display panel which intersect the extending direction of the video lines, and

the control circuit firstly inputs the start pulse to the fourth operation control circuit of the second shift register circuit and, thereafter, inputs the start pulse to the first operation control circuit of the first shift register circuit at outputting timing of the acquisition pulse firstly outputted from the first shift register circuit or firstly inputs the start pulse to the second operation control circuit of the first shift register circuit and, thereafter, inputs the start pulse to the third operation control circuit of the second shift register circuit at outputting timing of the acquisition pulse firstly outputted from the second shift register circuit.

(7) In the display device having the constitution (6), the display panel includes a plurality of scanning lines and a scanning line drive circuit which supplies scanning voltages to the plurality of scanning lines,

the video line drive circuit includes a first control signal generating circuit and a second control signal generating circuit on both ends thereof in the longitudinal direction,

the scanning line drive circuit is arranged on another side out of two sides of the display panel in the extending direction of the video lines, and

a control signal is supplied to the scanning line drive circuit from either one of the first control signal generating circuit and the second control signal generating circuit of the video line drive circuit.

(8) In the display device having the constitution (6), the display panel includes a plurality of scanning lines and a first scanning line drive circuit and a second scanning line drive circuit which supply scanning voltages to the plurality of scanning lines,

the video line drive circuit forms a first control signal generating circuit, a second control signal generating circuit and a third control signal generating circuit on both ends thereof and on a center portion thereof in the longitudinal direction,

the first scanning line drive circuit is arranged on another side out of two sides of the display panel along the extending direction of the video lines,

the second scanning line drive circuit is arranged on one side out of two sides of the display panel along the extending direction of the video lines and at a position closer to the display panel than the video line drive circuit,

a control signal is supplied to the first scanning line drive circuit from either one of the first control signal generating circuit and the third control signal generating circuit arranged on both ends of the video line drive circuit in the longitudinal direction, and

a control signal is supplied to the second scanning line drive circuit from the second control signal generating circuit arranged on a center portion of the video line drive circuit.

(9) In the display device having any one of the constitutions (1) to (8), the video lines are constituted of video lines of first color to mth (m≧2) color, and

the display device includes a selection switch circuit which connects the video lines of respective colors to corresponding video voltage output terminals of the video line drive circuit.

(10) In the display device having the constitution (9), the video lines are constituted of video lines of first color to third color, and

the selection switch circuit connects the video line of first color and the corresponding video voltage output terminal of the video line drive circuit during a first period within 1 horizontal display period, connects the video line of second color and the corresponding video voltage output terminal of the video line drive circuit during a second period within 1 horizontal display period, and connects the video line of third color and the corresponding video voltage output terminal of the video line drive circuit during a third period within 1 horizontal display period.

To briefly explain advantageous effects obtained by typical inventions among the inventions disclosed in this specification, they are as follows.

According to the display device of the present invention, it is possible to mount the video line drive circuit on a lateral side of the display panel while reducing a vertical picture frame size of the display panel.

### BRIEF DESCRIPTION OF THE DRAWINGS

FIG. 1 is a block diagram showing the schematic constitution of a video line drive circuit according to an embodiment of the present invention;

FIG. 2 is a block diagram showing the schematic constitution of a liquid crystal display module according to the embodiment of the present invention;

FIG. 3 is a view showing the input order of display data inputted from the outside and display data outputted from video voltage output terminals of the video line drive circuit according to the embodiment of the present invention;

FIG. 4 is a timing chart of the video line drive circuit shown in FIG. 2;

FIG. 5 is a block diagram showing the schematic constitution of a liquid crystal display module of a modification of the embodiment of the present invention;

FIG. 6 is a timing chart of the video line drive circuit shown in FIG. 2;

FIG. 7 is a block diagram showing the schematic constitution of a conventional liquid crystal display module; and

FIG. 8 is a view showing a state in which a video line drive circuit is mounted on a lateral side of a liquid crystal display panel.

### DESCRIPTION OF THE PREFERRED EMBODIMENTS

Hereinafter, an embodiment of the present invention is explained in detail in conjunction with drawings.

Here, in all drawings for explaining the embodiment, parts having identical functions are given same symbols and their repeated explanation is omitted.

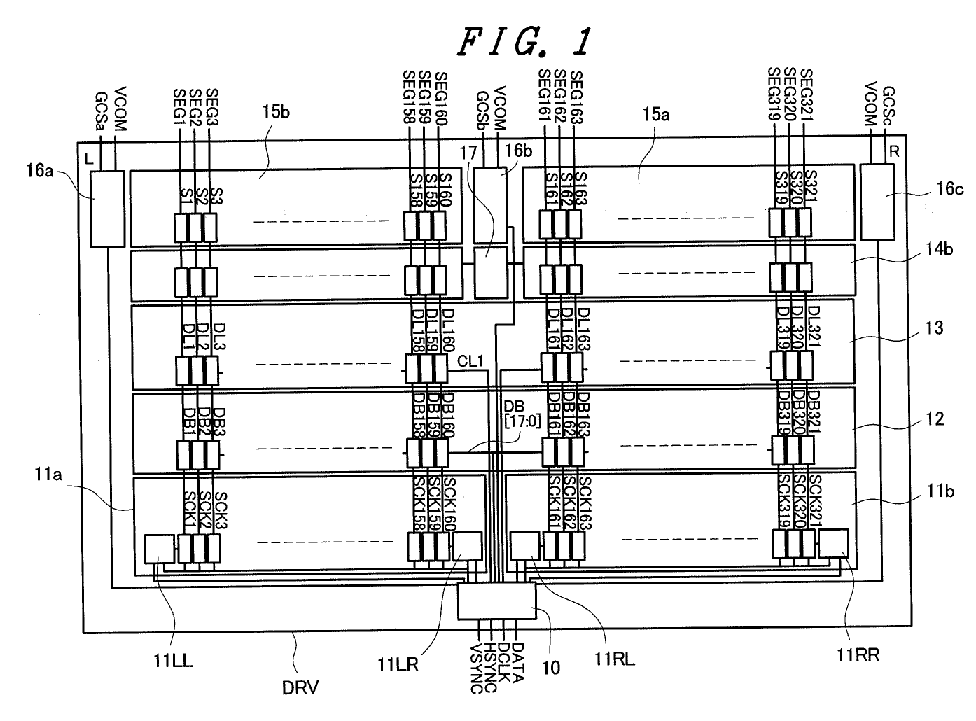

FIG. 1 is a block diagram showing the schematic constitution of a video line drive circuit (DRV) according to an embodiment of the present invention. As shown in FIG. 1, the video line drive circuit (DRV) of this embodiment includes a control circuit 10, a shift register circuit (11a, 11b), a bit latch circuit 12, a line latch circuit 13, a D/A converting circuit (14a, 14b), an output circuit (15a, 15b), a scanning line control signal/counter voltage generating circuit (16a, 16b, 16c) and a gradation voltage generating circuit 17.

In this embodiment, display data (DATA) inputted from the outside is constituted of 18 bits (6 bits for each color of R, G, B). The gradation voltage generating circuit 17 generates gradation voltages of 64 (2⁶) gradations from a gradation reference voltage of nine values inputted from the internal power source circuit (not shown in the drawing).

Further, the shift register circuit (11a, 11b) of the video line drive circuit (DRV) of this embodiment generates acquisition pulses which are synchronized with a dot clock (DCLK) based on the dot clock (DCLK) inputted from the outside. Here, in FIG. 1, the acquisition pulses outputted from the shift register circuits (11a, 11b) are indicated by symbols SCK1 to SCK321.

The bit latch circuit 12 sequentially acquires display data inputted from the outside in response to the acquisition pulses outputted from the shift register circuit (11a, 11b). In FIG. 1, the display data stored in the bit latch circuit 12 are indicated by symbols DB1 to DB321.

The line latch circuit 13 collectively acquires the display data stored in the bit latch circuit 12 in response to an outputting timing control clock (CL1) outputted from the control circuit 10. In FIG. 1, the display data stored in the line latch circuit 13 are indicated by symbols DL1 to DL321.

The D/A converting circuit (14a, 14b) selects gradation voltages corresponding to the display data stored in the line latch circuit 13 out of gradation voltages of 64 gradations generated by the gradation voltage generating circuit 17, and outputs these selected gradation voltages.

The output circuit (15a, 15b) amplifies (current amplification) the gradation voltages outputted from the D/A converting circuit (14a, 14b), and outputs the amplified gradation voltages to the respective corresponding video voltage output terminals. In FIG. 1, the gradation voltages outputted from the output circuit (15a, 15b) are indicated by symbols S1 to S321, and the video voltage output terminals are indicated by symbols SEG1 to SEG321.

Further, the scanning line control signal/counter voltage generating circuit (16a, 16b, 16c) generates a scanning line control signal outputted to a scanning line drive circuit (GDRV) and a counter voltage (VCOM) outputted to counter electrodes.

This embodiment is characterized in that the shift register circuit is divided in two in the lateral direction, that is, into a first shift register circuit (11a) and a second shift register circuit (11b), a first operation control circuit (STHLL) and a second operation control circuit (STHLR) are formed one on each end of the first shift register circuit (11a), and a third operation control circuit (STHRL) and a fourth operation control circuit (STHRR) are formed one on each end of the second shift register circuit (11b).

Further, the control circuit 10 selects one operation control circuit out of the first operation control circuit (STHLL) and the second operation control circuit (STHLR) of the first shift register circuit (11a) and inputs a start pulse to the selected operation control circuit and, at the same time, the control circuit 10 selects one operation control circuit out of the third operation control circuit (STHRL) and the fourth operation control circuit (STHRR) of the second shift register circuit (11b) and inputs a start pulse to the selected operation control circuit.

Further, in this embodiment, two scanning line control signal/counter voltage generating circuits (16a, 16c) are arranged on both ends of the video line drive circuit (DRV) in the longitudinal direction, and one scanning line control signal/counter voltage generating circuit (16b) is arranged at the center of the video line drive circuit (DRV) in the longitudinal direction.

Hereinafter, a mounting example of the video line drive circuit (DRV) of this embodiment is explained.

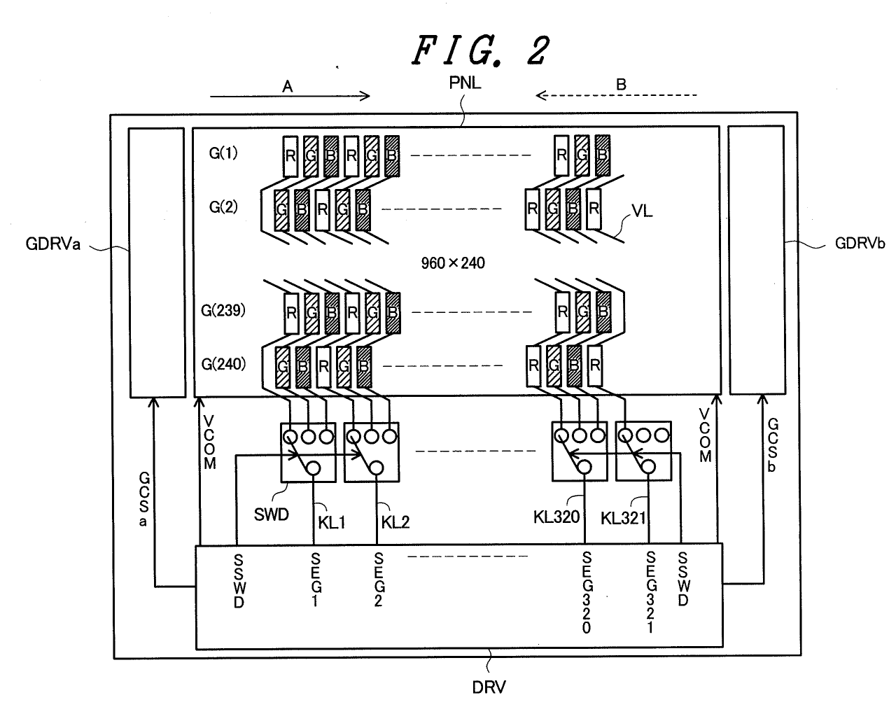

FIG. 2 is a block diagram showing the schematic constitution of a liquid crystal display module according to the embodiment of the present invention. In the liquid crystal display panel shown in FIG. 2, the total number of sub pixels is 230400(=(320×3)×240). As shown in FIG. 2, in the neighboring display lines, the sub pixels of the same color of R, G, B are arranged in a zigzag manner for every display line such that the sub pixels of the same color do not overlap each other and are displaced laterally by 1 sub pixel. That is, in an example shown in FIG. 2, the nth G sub pixel in the (n+1)th display line is arranged to be positioned below the R sub pixel of the nth display line, and the nth G sub pixel in the (n+2)th display line is arranged to be positioned below the G sub pixel of the nth display line.

Accordingly, in the liquid crystal display panel (PNL) shown in FIG. 2, the number (321) of the video lines (VL) of R is set larger than the number (320) of other video lines (VL) of G, B by one line.

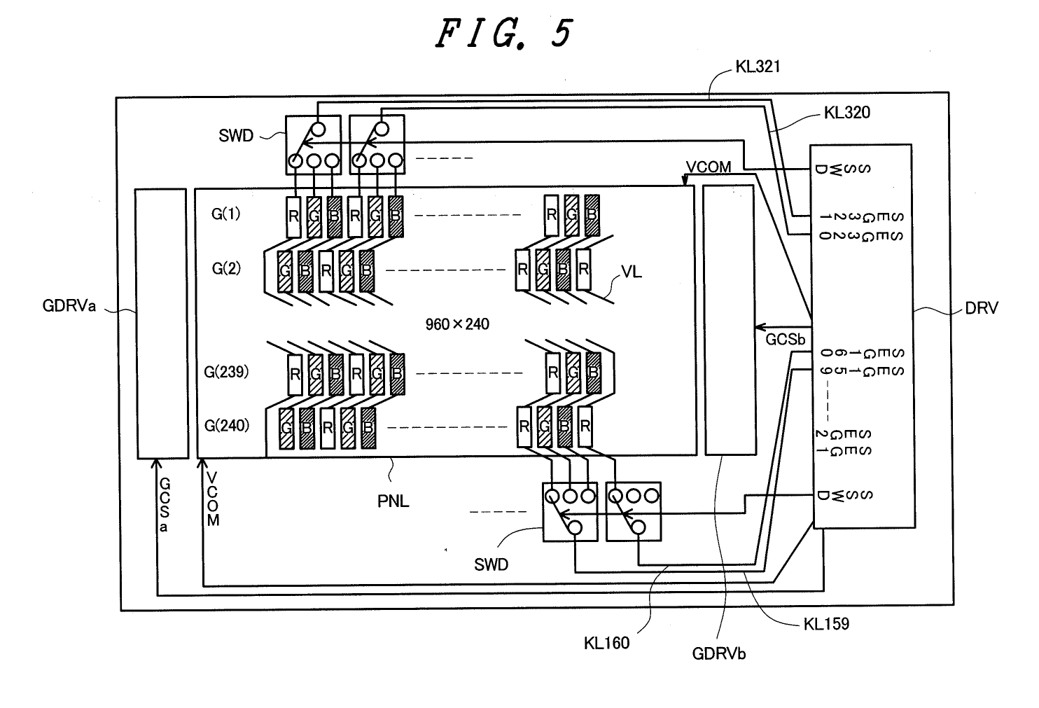

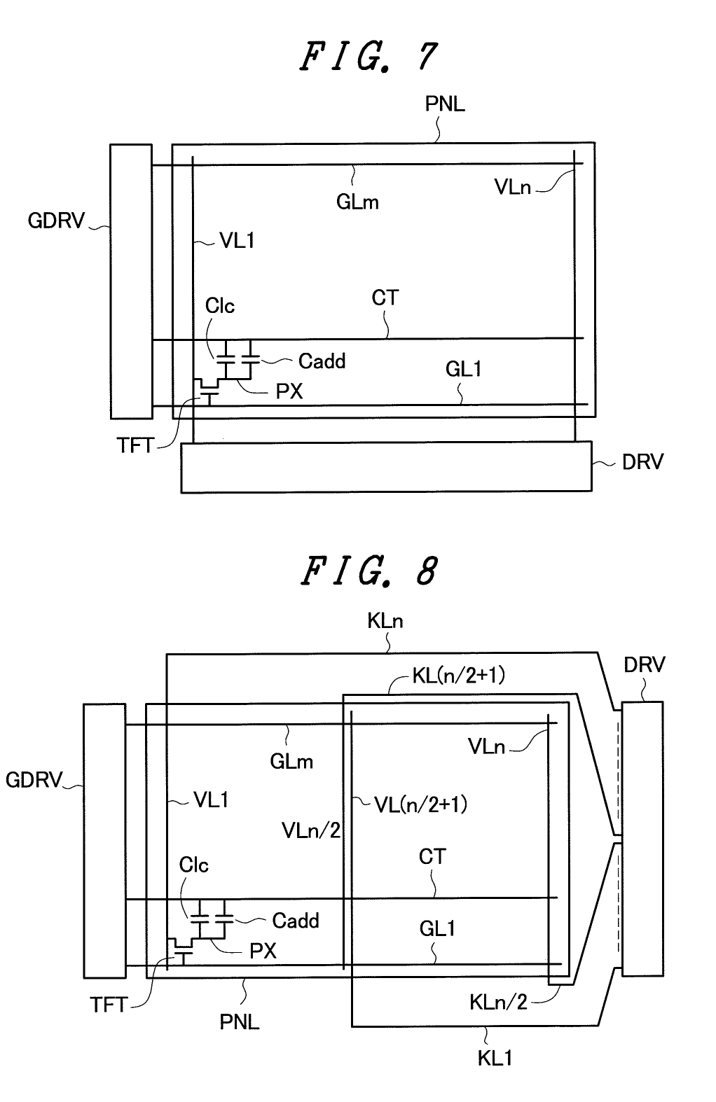

Further, equivalent circuits of the sub pixels of the liquid crystal display panels (PNL) shown in FIG. 2 and FIG. 5 are equal to the equivalent circuits shown in FIG. 7 and FIG. 8.

Here, the liquid crystal display panel (PNL) shown in FIG. 2 is configured as follows. That is, a first substrate on which pixel electrodes (PX), thin film transistors (TFT) and the like are formed and a second substrate on which color filters and the like are formed are made to overlap each other with a predetermined gap therebetween. Both substrates are adhered to each other by a sealing material formed in a frame shape between peripheral portions of both substrates. Liquid crystal is filled and sealed in the inside of the sealing material between both substrates through a liquid crystal filling port formed in a portion of the sealing material. Further, a polarizer is adhered to outer sides of both substrates.

Here, the counter electrodes (CT) are formed on a second substrate side in a TN-method or VA-method liquid crystal display panel, or are formed in a first substrate side in a IPS-method liquid crystal display panel. Further, since the present invention is not relevant to the inner structure of the liquid crystal panel, the detailed explanation of the internal structure of the liquid crystal panel is omitted. Further, the present invention is applicable to a liquid crystal panel having any structure.

In the liquid crystal display module of the embodiment shown in FIG. 2, the video line drive circuit (DRV) is arranged on a lower side of the liquid crystal display panel (PNL) (outside one side out of two sides which intersect the extending direction of the video lines (VL)).

In the embodiment, a selection switch circuit (SWD) is formed between video voltage output terminals (SEG1 to SEG321) of the video line drive circuit (DRV) and the video lines (VL) of R, G, B. The selection switch circuit (SWD) is controlled by the control circuit 10 of the video line drive circuit (DRV).

The selection switch circuit (SWD), based on an instruction from the control circuit 10, connects the video line of R and the corresponding video voltage output terminal of the video line drive circuit (DRV) during a first period within 1 horizontal display period, for example, connects the video line of G and the corresponding video voltage output terminal of the video line drive circuit (DRV) during a second period within 1 horizontal display period, and connects the video line of B and the corresponding video voltage output terminal of the video line drive circuit (DRV) during a third period within 1 horizontal display period.

In FIG. 2, symbol GDRVa indicates a scanning line drive circuit for reverse scanning, and the scanning line drive circuit (GDRVa) for reverse scanning is arranged on another side out of two sides of the liquid crystal display panel (PNL) along the extending direction of the video lines (VL). To the scanning line drive circuit (GDRVa) for reverse scanning, a scanning line control signal (GCSa) is supplied from the scanning line control signal/counter voltage generating circuit (16a).

Further, symbol GDRVb indicates a scanning line drive circuit for positive scanning, and the scanning line drive circuit (GDRVb) for positive scanning is arranged on another side out of two sides of the liquid crystal display panel (PNL) along the extending direction of the video lines (VL). To the scanning line drive circuit (GDRVb) for positive scanning, a scanning line control signal (GCSc) is supplied from the scanning line control signal/counter voltage generating circuit (16c).

Here, in FIG. 2, the case in which the video line drive circuit (DRV) is constituted of one semiconductor chip is illustrated. However, the video line drive circuit (DRV) may be directly formed on the glass substrate using a thin film transistor which forms a semiconductor layer thereof using low-temperature poly-silicon, for example. In the same manner, a partial circuit of the video line drive circuit (DRV) may be divided so as to form the video line drive circuit (DRV) using a plurality of semiconductor chips. Further, a partial circuit of the video line drive circuit (DRV) may be directly formed on a glass substrate using a thin film transistor which forms a semiconductor layer thereof using low-temperature poly-silicon, for example. Further, the video line drive circuit (DRV) or a partial circuit of the video line drive circuit (DRV) maybe formed on a flexible printed circuit board in place of the glass substrate.

Further, FIG. 2 shows the case in which the scanning line drive circuit (GDRVa, GDRVb) is directly formed on the glass substrate using a thin film transistor which forms a semiconductor layer thereof using low-temperature poly-silicon. However, the scanning line drive circuit (GDRVa, GDRVb) may be formed of a semiconductor chip.

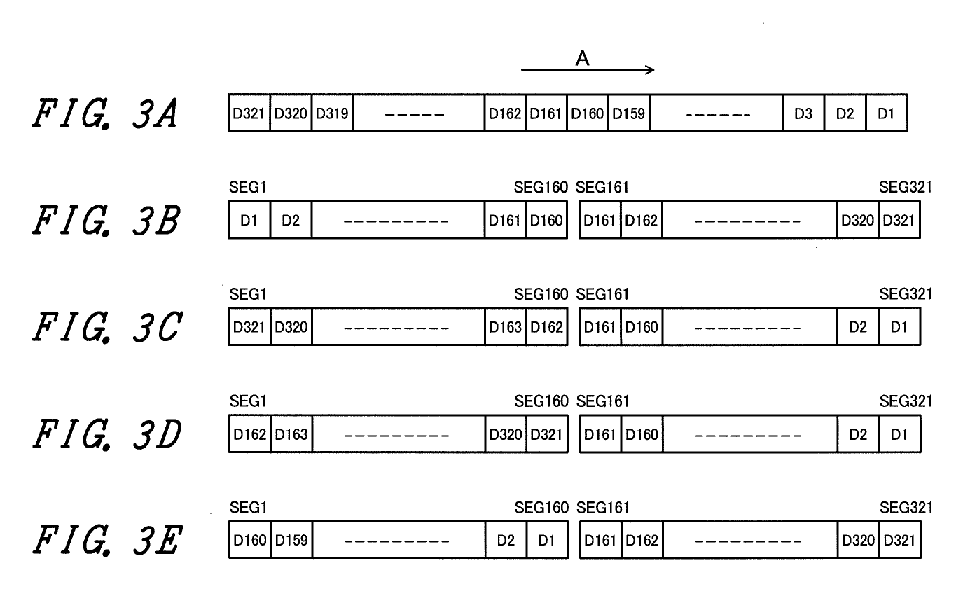

FIG. 3 is a view showing the input order of display data (DATA) inputted from the outside and display data outputted from the video voltage output terminals (SEG1 to SEG 321) of the video line drive circuit (DRV) according to this embodiment.

To the video line drive circuit (DRV) of this embodiment, as indicated by an arrow A shown in FIG. 3, the display data (DATA) is inputted in order from D1 to D321.

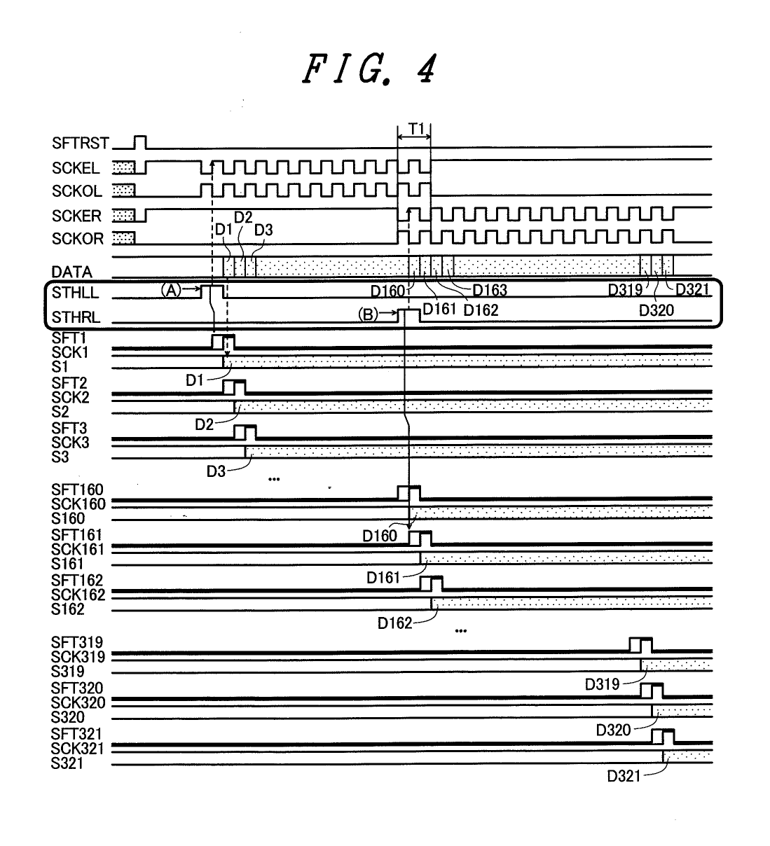

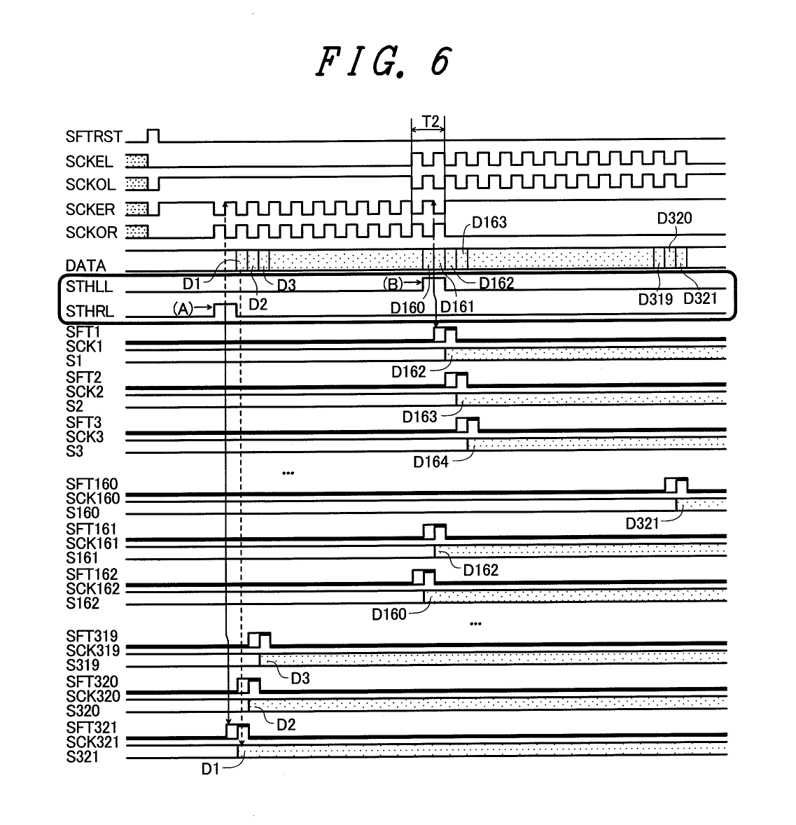

FIG. 4 is a timing chart of the video line drive circuit (DRV) shown in FIG. 2. Here, in FIG. 4 and FIG. 6 described later, symbols SCKEL, SCKOL indicate operational clocks of the first shift register circuit (11a), and symbols SCKER, SCKOR indicate operational clocks of the second shift register circuit (11b). Symbol SCK* indicates an acquisition pulse, symbol SFT* indicates a shift clock for generating the acquisition pulse (SCK*), and symbol S* indicates the order of data outputted from the video voltage output terminals (SEG1 to SEG 321) of the video line drive circuit (DRV).

As shown in FIG. 4, in the liquid crystal display module shown in FIG. 2, at the time of performing the positive scanning (in the direction indicated by an arrow A in FIG. 2), the control circuit 10 of the video line drive circuit (DRV) firstly inputs the start pulse to the first operation control circuit (STHLL) of the first shift register circuit (11a) (see (a) in FIG. 4) and, thereafter, inputs the start pulse to the third operation control circuit (STHRL) of the second shift register circuit (11b) at outputting timing of the acquisition pulse firstly outputted from the second shift register circuit (11b) (that is, at inputting timing of the display data D161 inputted from the outside) (see (b) in FIG. 4). Here, in the video line drive circuit (DRV), the display data outputted from the video voltage output terminals (SEG1 to SEG321) is indicated by (b) shown in FIG. 3.

Further, in the liquid crystal display module shown in FIG. 2, at the time of performing the reverse scanning (in the direction indicated by an arrow B in FIG. 2), the control circuit 10 of the video line drive circuit (DRV) firstly inputs the start pulse to the fourth operation control circuit (STHRR) of the second shift register circuit (11b) and, thereafter, inputs the start pulse to the second operation control circuit (STHLR) of the first shift register circuit (11a) at outputting timing of the acquisition pulse firstly outputted from the first shift register circuit (11a) (that is, at inputting timing of the display data D162 inputted from the outside). Here, in the video line drive circuit (DRV), the display data outputted from the video voltage output terminals (SEG1 to SEG321) is indicated by (c) shown in FIG. 3.

FIG. 5 is a block diagram showing the schematic constitution of a liquid crystal display module of a modification of the embodiment of the present invention. Hereinafter, the liquid crystal display module shown in FIG. 5 is explained by focusing on the constitution which makes the liquid crystal display module shown in FIG. 5 different from the liquid crystal display module shown in FIG. 1.

In the liquid crystal display module of the embodiment shown in FIG. 5, the video line drive circuit (DRV) is arranged on a lateral side of the liquid crystal display panel (PNL) (outside one side out of two sides of the liquid crystal display panel (PNL) along the extending direction of the video lines (VL)).

In the liquid crystal display module shown in FIG. 5, as explained in conjunction with FIG. 8, the plurality of video lines is divided into the first group and the second group. The respective video lines of the first group are connected to the video voltage output terminals (SEG161 to SEG 321) corresponding to the second shift register circuit (11b) of the video line drive circuit (DRV) via the connection lines (KL161 to KL321) formed on an upper side of the liquid crystal display panel (PNL) (outside another side) out of two sides which intersect the extending direction of the video lines (VL)). Further, the respective video lines of the second group are connected to the video voltage output terminals (SEG1 to SEG160) corresponding to the first shift register circuit (11a) of the video line drive circuit (DRV) via the connection lines (KL1 to KL160) formed on a lower side of the liquid crystal display panel (PNL) (outside one side) out of two sides which intersect the extending direction of the video lines (VL)).

Further, in the liquid crystal display module shown in FIG. 5, to the scanning line drive circuit (GDRVa) for reverse scanning, a scanning line control signal (GCSa) is supplied from the scanning line control signal/counter voltage generating circuit (16a).

Still further, since the scanning line control signal (GCSc) and the connection lines (KL161 to KL321) intersect each other, to the scanning line drive circuit (GDRVb) for positive scanning, a scanning line control signal (GCSc) is supplied from the scanning line control signal/counter voltage generating circuit (16b) formed at the center of the video line drive circuit (DRV) in the longitudinal direction.

FIG. 6 is a timing chart of the video line drive circuit shown in FIG. 5.

As shown in FIG. 6, in the liquid crystal display module shown in FIG. 5, at the time of performing the positive scanning (in the direction indicated by the arrow A in FIG. 2), the control circuit 10 of the video line drive circuit (DRV) firstly inputs the start pulse to the fourth operation control circuit (STHRR) of the second shift register circuit (11b) (see (a) in FIG. 6) and, thereafter, inputs the start pulse to the first operation control circuit (STHLL) of the first shift register circuit (11a) at outputting timing of the acquisition pulse firstly outputted from the first shift register circuit (11a) (that is, at inputting timing of the display data D162 inputted from the outside) (see (b) in FIG. 6). Here, in the video line drive circuit (DRV), the display data outputted from the video voltage output terminals (SEG1 to SEG321) is indicated by (d) shown in FIG. 3.

Further, in the liquid crystal display module shown in FIG. 5, at the time of performing the reverse scanning (in the direction indicated by the arrow B in FIG. 2), the control circuit 10 of the video line drive circuit (DRV) firstly inputs the start pulse to the second operation control circuit (STHLR) of the first shift register circuit (11a) and, thereafter, inputs the start pulse to the fourth operation control circuit (STHRR) of the second shift register circuit (11b) at outputting timing of the acquisition pulse firstly outputted from the second shift register circuit (11b) (that is, at inputting timing of the display data D161 inputted from the outside). Here, in the video line drive circuit (DRV), the display data outputted from the video voltage output terminals (SEG1 to SEG321) is indicated by (e) shown in FIG. 3.

Here, in this embodiment, as shown in FIG. 4 and FIG. 6, operation clocks are not inputted to the first shift register circuit (11a) and the second shift register circuit (11b) during a period other than a period in which the acquisition pulse is generated and outputted. Due to such an operation, it is possible to reduce the power consumption.

That is, as shown in FIG. 4, operation clocks SCKEL, SCKOL are inputted to the first shift register circuit (11a) during the first half period within 1 horizontal display period, and operation clocks SCKER, SCKOR are inputted to the second shift register circuit (11b) during the latter half period within 1 horizontal display period. Here, in FIG. 4, both of the operation clocks SCKEL, SCKOL and the operation clocks SCKER, SCKOR are respectively inputted to the first shift register circuit (11a) and the second shift register circuit (11b) during a period T1.

Further, as shown in FIG. 6, operation clocks SCKEL, SCKOL are inputted to the first shift register circuit (11a) during the latter half period within 1 horizontal display period, and operation clocks SCKER, SCKOR are inputted to the second shift register circuit (11b) during the first half period within 1 horizontal display period. Here, in FIG. 6, both of the operation clocks SCKEL, SCKOL and the operation clocks SCKER, SCKOR are respectively inputted to the first shift register circuit (11a) and the second shift register circuit (11b) during a period T2.

Further, in the above-mentioned explanation, although the explanation has been made with respect to the embodiment in which the present invention is applied to the liquid crystal display device, the present invention is not limited to such an embodiment. For example, it is needless to say that the present invention is applicable to a display device such as an organic EL display device which includes sub pixels in general.

Although the invention made by inventors of the present invention has been specifically explained in conjunction with the embodiment heretofore, it is needless to say that the present invention is not limited to the above-mentioned embodiment and various modifications are conceivable without departing from the gist of the present invention.

What is claimed is:

1. A display device comprising:
a display panel having a plurality of video lines; and
a video line drive circuit which supplies a video voltage to the respective video lines, the video line drive circuit including a control circuit and a shift register circuit which outputs a plurality of acquisition pulses, wherein
the shift register circuit is divided into two shift register circuits consisting of a first shift register circuit and a second shift register circuit,
the first shift register circuit forms a first operation control circuit on end thereof and a second operation control circuit on another end thereof,
the second shift register circuit forms a third operation control circuit one end thereof and a fourth operation control circuit on another end thereof, and
the control circuit selects one operation control circuit out of the first operation control circuit and the second operation control circuit of the first shift register circuit and inputs a start pulse to the selected operation control circuit, and selects one operation control circuit out of the third operation control circuit and the fourth operation control circuit of the second shift register circuit and inputs a start pulse to the selected operation control circuit.

2. A display device according to claim 1, wherein the video line drive circuit includes:
a bit latch circuit which sequentially latches a plurality of display data inputted from the outside in response to the acquisition pulses which are sequentially outputted from the shift register circuit;
a line latch circuit which latches the plurality of display data latched by the bit latch circuit;
a D/A converting circuit which generates a plurality of video voltages corresponding to the display data based on the plurality of display data latched by the line latch circuit; and
an output circuit which outputs the plurality of video voltages outputted from the D/A converting circuit to the respective corresponding video lines.

3. A display device according to claim 2, wherein an operational clock is not inputted to the first shift register circuit and the second shift register circuit during periods other than a period in which the acquisition pulses are generated and outputted.

4. A display device according to claim 1, wherein the video line drive circuit is arranged on one side out of two sides of the display panel which intersect the extending direction of the video lines, and
the control circuit firstly inputs the start pulse to the first operation control circuit of the first shift register circuit and, thereafter, inputs the start pulse to the third operation control circuit of the second shift register circuit at outputting timing of the acquisition pulse firstly outputted from the second shift register circuit or firstly inputs the start pulse to the fourth operation control circuit of the second shift register circuit and, thereafter, inputs the start pulse to the second operation control circuit of the first shift register circuit at outputting timing of the acquisition pulse firstly outputted from the first shift register circuit.

5. A display device according to claim 4, wherein the display panel includes a plurality of scanning lines and a scanning line drive circuit which supplies scanning voltages to the plurality of scanning lines,
the video line drive circuit includes a first control signal generating circuit and a second control signal generating circuit which control the scanning line drive circuit on each end thereof in the longitudinal direction,
the scanning line drive circuit is arranged on one side out of two sides of the display panel in the extending direction of the video lines, and
a control signal is supplied to the scanning line drive circuit from either one of the first control signal generating circuit and the second control signal generating circuit of the video line drive circuit.

6. A display device according to claim 1, wherein the video line drive circuit is arranged on one side out of two sides of the display panel along the extending direction of the video lines,
the plurality of video lines is divided into a first group and a second group,
the respective video lines of the first group are connected to video voltage output terminals of the video line drive circuit corresponding to the second shift register circuit via connection lines arranged outside one side out of two sides of the display panel which intersect the extending direction of the video lines,
the respective video lines of the second group are connected to video voltage output terminals of the video line drive circuit corresponding to the first shift register circuit via connection lines arranged outside another side out of two sides of the display panel which intersect the extending direction of the video lines, and
the control circuit firstly inputs the start pulse to the fourth operation control circuit of the second shift register circuit and, thereafter, inputs the start pulse to the first operation control circuit of the first shift register circuit at outputting timing of the acquisition pulse firstly outputted from the first shift register circuit or firstly inputs the start pulse to the second operation control circuit of the first shift register circuit and, thereafter, inputs the start pulse to the third operation control circuit of the second shift register circuit at outputting timing of the acquisition pulse firstly outputted from the second shift register circuit.

7. A display device according to claim 6, wherein the display panel includes a plurality of scanning lines and a scanning line drive circuit which supplies scanning voltages to the plurality of scanning lines,
the video line drive circuit includes a first control signal generating circuit and a second control signal generating circuit on both ends thereof in the longitudinal direction,
the scanning line drive circuit is arranged on another side out of two sides of the display panel in the extending direction of the video lines, and
a control signal is supplied to the scanning line drive circuit from either one of the first control signal generating circuit and the second control signal generating circuit of the video line drive circuit.

8. A display device according to claim 6, wherein the display panel includes a plurality of scanning lines and a first scanning line drive circuit and a second scanning line drive circuit which supply scanning voltages to the plurality of scanning lines,
the video line drive circuit forms a first control signal generating circuit, a second control signal generating circuit and a third control signal generating circuit on both ends thereof and on a center portion thereof in the longitudinal direction,
the first scanning line drive circuit is arranged on another side out of two sides of the display panel along the extending direction of the video lines,
the second scanning line drive circuit is arranged on one side out of two sides of the display panel along the extending direction of the video lines and at a position closer to the display panel than the video line drive circuit,
a control signal is supplied to the first scanning line drive circuit from either one of the first control signal generating circuit and the third control signal generating circuit arranged on both ends of the video line drive circuit in the longitudinal direction, and
a control signal is supplied to the second scanning line drive circuit from the second control signal generating circuit arranged on a center portion of the video line drive circuit.

9. A display device according to claim 1, wherein the video lines are constituted of video lines of first color to mth (m≧2) color, and
the display device includes a selection switch circuit which connects the video lines of respective colors to corresponding video voltage output terminals of the video line drive circuit.

10. A display device according to claim 9, wherein the video lines are constituted of video lines of first color to third color, and
the selection switch circuit connects the video line of first color and the corresponding video voltage output terminal of the video line drive circuit during a first period within 1 horizontal display period, connects the video line of second color and the corresponding video voltage output terminal of the video line drive circuit during a second period within 1 horizontal display period, and connects the video line of third color and the corresponding video voltage output terminal of the video line drive circuit during a third period within 1 horizontal display period.
